(19) United States
(12) Patent Application Publication
(10) Pub. No.: US 2014/0232052 A1
(43) Pub. Date: Aug. 21, 2014

(54) MULTI-USE ADJUSTABLE VISE

(71) Applicant: Frank Mendez, Mayer, AZ (US)

(72) Inventor: Frank Mendez, Mayer, AZ (US)

(21) Appl. No.: 13/770,675

(22) Filed: Feb. 19, 2013

(51) Int. Cl. B25B 1/22

(52) U.S. Cl. CPC B25B 1/22
USPC 269/95

(57) ABSTRACT

A multi-functional universal vise having a mounting unit and at least one work piece clamping unit that is capable of being rotated 360 degrees in relation to the mounting unit and that is capable of being extended from, and retracted toward, the mounting unit. The work piece clamping unit may have a generally “M” or “W” shaped portion.

### FIELD OF INVENTION

The present invention generally relates to a multi-functional universal vise having a mounting unit and at least one generally “M” shaped rotating and extendable-retractable clamping unit. The mounting unit can be mounted to a variety of structures including workbenches and truck beds while the “M” shaped rotating and extendable-retractable clamping unit enables a user to rotate, extend and/or retract a work piece secured within the “M” shaped clamping unit thereby enabling a user to reposition the work piece without having to remove and readjust or reposition the work piece itself that is positioned within the vise. The multi-functional universal vise may also include a connecting member positioned between the mounting member and the “M” shaped rotating and extendable-retractable clamping unit.

### BACKGROUND OF THE INVENTION

A vise is a mechanical screw-type apparatus that enables a user to hold or clamp a work piece into place so that the user can perform work on the work piece with tools such as saws, planes, drills, mills, screwdrivers, sandpaper, etc. Vises typically have one fixed jaw and another parallel jaw for holding the work piece that is moved towards or away from the fixed jaw by a screw.

Vises are usually clamped or bolted onto the top of a work bench and, as a result, a work piece placed within the vise must be removed from the vise and readjusted or repositioned within the vise in order to work on different areas of the work piece. Accordingly, there is a need for a multi-use vise, that is adaptable for mounting on a variety of structures and surfaces, where a portion of the vise is also capable of rotating, extending and retracting thereby enabling a work piece positioned within the vise to be moved in a variety of positions without removing the work piece from the vise so that a user can work on almost any area of the work piece. Such a multi-use vise functions as a third hand or arm and creates a safer, more positive, and cost effective work environment that promotes real time productivity.

### SUMMARY OF THE INVENTION

The present invention is generally directed to a multi-functional universal use vise having a mounting unit and a work piece clamping unit connected to the mounting unit such that the work piece clamping unit is capable of being rotated 360 degrees and is extendable from, and retractable toward, the mounting unit. The work piece mounting unit may include one or more “M” shaped members where each of the “M” shaped members has a first and a second end and a clamp connected to the first and second ends of the “M” shaped member(s). The clamps may each include a fixed jaw member attached to a first end of the “M” shaped member, a moveable jaw member attached to the second end of the “M” shaped member, a screw member connected to the moveable jaw member, and a lever connected to the screw member so that the lever can turn the screw member and thereby move the moveable jaw member toward the fixed jaw member. In addition, each of the jaw members may have a plurality of teeth members for grasping a work piece.

In another exemplary embodiment, the multi-functional universal use vise includes a mounting unit having a slot member, at least one work piece clamping unit, and a connecting member connecting the mounting unit to the one or more work piece clamping units where the connecting member has a first end that fits within the slot of the mounting unit and a second end that is connectable to at least one of the work piece clamping units. The mounting unit may include a clamp member and a screw member for mounting the mounting unit to a structure. The one or more work piece clamping units may each be capable of being rotated 360 degrees in relation to the connecting member or in relation to one or more of the work piece clamping units or any number of connectors that connect the one or more work piece clamping units. In addition, the one or more work piece clamping units may each be capable of being extended from, or retracted toward, the connecting member or one or more of the work piece clamping units or any number of connectors that connect the one or more work piece clamping units.

In yet another exemplary embodiment, the one or more work piece clamping units may include one or more generally “M” shaped members where the “M” shaped members each include a clamp having a fixed jaw member attached to a first end of the “M” shaped member and a moveable jaw member attached to the second end of the “M” shaped member. The clamps each further include a screw member connected to the moveable jaw member and a lever connected to the screw member so that the lever can turn the screw member and thereby move the movable jaw member toward the fixed jaw member. In addition, each of the jaw members may have a plurality of teeth members for grasping a work piece.

The mounting unit may have several different embodiments depending on the structure to which the vise will be mounted. For example, if the vise will be mounted on a typical work bench, the mounting unit may include a clamp member and a screw member where the clamp member is capable of being secured to the lip of the work bench and the slot in the mounting member is positioned on an outer surface of the clamp member (as shown in FIGS. 1-3) for retaining an end of a work piece clamping unit or an end of a connecting member. In another example, if the vise will be mounted to a truck bed, the mounting unit may include a clamp member and a screw member where the clamp member is capable of being secured to the bed of a truck and the slot in the mounting member is positioned on an outer upper surface of the clamp member (as shown in FIGS. 4-9) for retaining an end of a work piece clamping unit or an end of a connecting member. In still another example, if the vise will be mounted on a truck rail located underneath a truck, the mounting unit may include a clamp member and a screw member where a portion of the clamp member is a magnet (for attracting the metal rail of the truck) and the slot of the clamp member is positioned such that it extends downward and outward from the underside of a truck when the clamp member is secured to the rail of the truck.

### BRIEF DESCRIPTION OF THE DRAWINGS

The subject invention will hereinafter be described in conjunction with the appended drawing figures, wherein like numerals denote like elements, and

FIG. 1 is a perspective view of one exemplary embodiment of the multi-functional vise of the present invention;

FIG. 2 is an opposite perspective view of the exemplary embodiment of the vise shown in FIG. 1;

FIG. 3 is a side elevational view of the exemplary embodiment of the vise shown in FIGS. 1 and 2;

FIG. 4 is a perspective view of another exemplary embodiment of the multi-functional vise of the present invention;

FIG. 5 is an opposite perspective view of the exemplary embodiment of the vise shown in FIG. 4;

FIG. 6 is a side elevational view of the exemplary embodiment of the vise shown in FIGS. 4 and 5;

FIG. 7 is a perspective view of yet another exemplary embodiment of the multi-functional vise of the present invention;

FIG. 8 is an opposite perspective view of the exemplary embodiment of the vise shown in FIG. 7;

FIG. 9 is a side elevational view of the exemplary embodiment of the vise shown in FIGS. 7 and 8;

FIG. 10 is partial perspective view of an exemplary embodiment of an “M” shaped work piece clamping unit of the multi-functional vise of the present invention;

FIG. 11 is a perspective view of still another exemplary embodiment of the multi-functional vise of the present invention;

FIG. 12 is a perspective view of an exemplary embodiment of a mounting unit of the multi-functional vise of the present invention;

FIG. 13 is a side elevational view of the exemplary embodiment of the mounting unit of the multi-functional vise shown in FIG. 12; and

FIG. 14 is a perspective view of yet another exemplary embodiment of the multi-functional vise of the present invention.

### DETAILED DESCRIPTION OF EXEMPLARY EMBODIMENTS

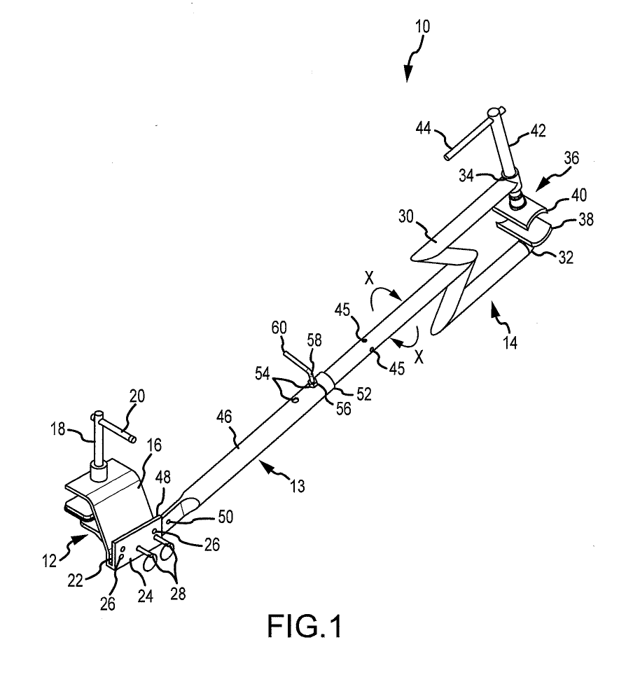

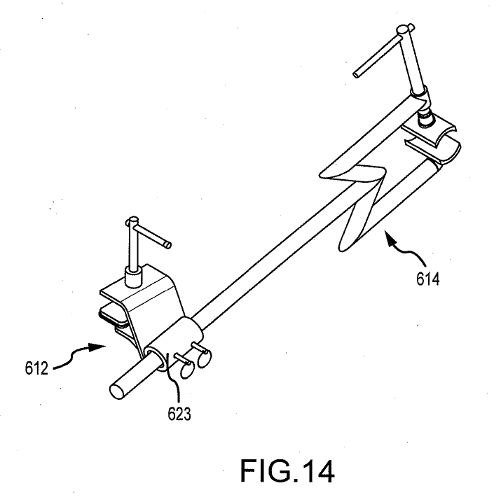

The multi-functional universal vise of the present invention generally provides a mounting unit for mounting to any type of solid structure and a work piece clamping unit connectable to the mounting unit wherein the work piece clamping unit is capable of being rotated 360 degrees and is extendable from and retractable toward the mounting unit. FIG. 1 is a perspective view of one exemplary embodiment of the multi-functional vise 10 of the present invention. Multi-functional vise 10 includes a mounting unit 12 and a work piece clamping unit 14 connected to the mounting unit 12 via a connecting member 13. However, it will be understood by those skilled in the art that the work piece clamping unit 14 may be directly connected to the mounting unit 12 without the need for a connecting member 13. The connecting member 13 enables the work piece clamping unit 14 to be extended further away from the mounting unit 12 in order to accommodate larger work pieces and in order to make it easier for a user to work on a work piece mounted in the work piece clamping unit in a variety of environments. However, it should also be understood by those skilled in the art that mounting unit 12 may comprise a sleeve 623 (as shown in FIG. 14) so that an end of the work piece clamping unit 14 (or even a rounded or cylindrical end of a connecting member 12) can be inserted into the sleeve 29 so that the work piece clamping unit can be extended and retracted within sleeve 29 of the mounting unit 12.

Work piece clamping unit 14 may include a generally “M” or “W” shaped member 30 (hereinafter referred to as “M” shaped member 30) which has a first end 32 and a second end 34 and a clamp 36 attached to the first and second ends 32, 34. Clamp 36 includes a fixed jaw member 38 attached to the first end 32 of “M” shaped member 30 and a moveable jaw member 40 attached to the second end 34 of the “M” shaped member 30. Clamp 36 further includes a screw member 42 connected to the moveable jaw member 40 and a lever 44 connected to the screw member 42 so that the lever 44 can turn the screw member 42 thereby moving the moveable jaw member 40 toward the fixed jaw member 38 so that a work piece can be retained within clamp 36. Further, work piece clamping unit 14 is capable of being rotated 360 degrees as noted by arrows X.

Mounting unit 12 includes a clamp member 16, a screw member 18 connected to the clamp member 16, and a lever 20 connected to the screw member 18 so that it can turn screw member 16 in clockwise and counterclockwise directions thereby closing and opening the jaws of clamp member 16. Mounting unit 12 further comprises a slot 22 with an outer wall 24 that contains openings 26 for receiving pin members 28. Connecting member 13 includes a main member 46 having a first end 48 with openings 50 contained therein and a second end 52 with openings 54 contained therein. Connecting member 13 also includes a screw member 58 capable of fitting within openings 54, a lever 60 as part of, or connected to, screw member 58 for turning screw member 58, and a nut 56 for tightening and securing screw member 58 within openings 54.

As shown in FIG. 1, first end 48 of connecting member 13 may comprise a flat portion with openings 50 capable of fitting within slot 22 of mounting unit 12. Openings 50 within first end 48 of connecting member 13 can be aligned with openings 26 in outer wall 24 of slot 22 so that pin members 28 can be inserted therethrough to connect the connecting member 13 to the mounting unit 12. In turn, work piece clamping unit 14 can be connected to connecting member 13 by inserting an end of work piece clamping member opposite the “M” shaped member into the second end 53 of connecting member 13. Work piece clamping unit 14 includes openings 45 therein that can be aligned with the openings 54 in connecting member 13. Lever 60 is then used to tighten screw member 58 through the openings 54 within the connecting member 13 and the openings 45 within the work piece clamping unit 14 to secure the work piece clamping unit 14 to the connecting member 13. The openings 45 in work piece clamping unit 14 extend along a length of work piece clamping unit 14 so that work piece clamping unit 14 can be secured within connecting member 13 at variety of positions thereby lengthening or shortening the position of the “M” shaped member 30 of the work piece clamping unit 14 in relation to the connecting member 13.

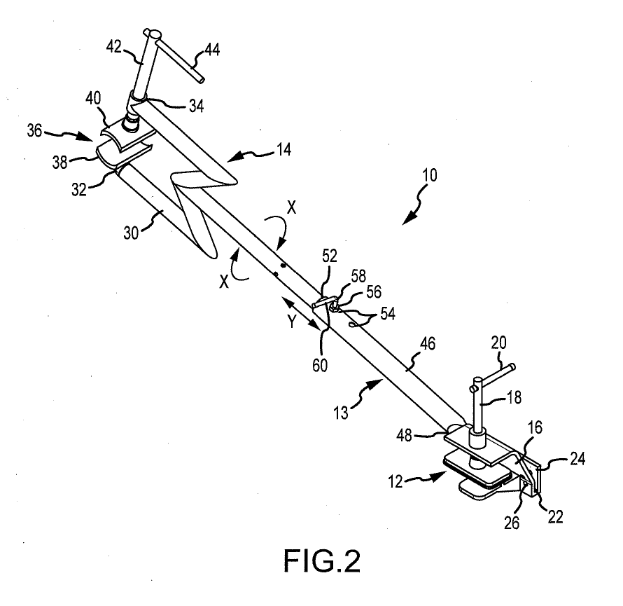

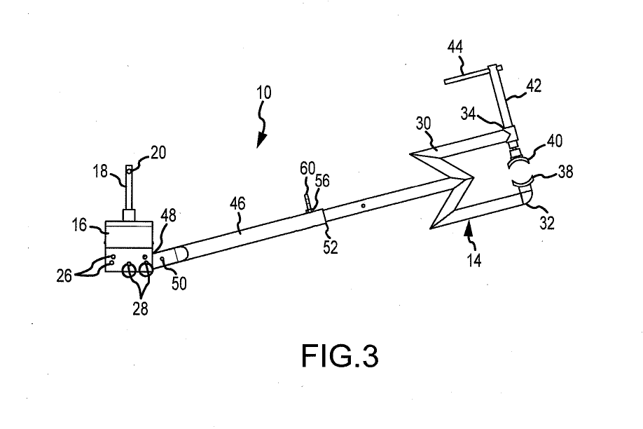

FIG. 2 is an opposite perspective view of the exemplary embodiment of the vise shown in FIG. 1 and FIG. 3 shows a side elevational view of the exemplary embodiment of the vise shown in FIGS. 1 and 2. As previously described with reference to FIG. 1, the work piece clamping unit 14 is capable of being rotated 360 degrees as shown by arrows X in FIG. 2. In addition, the work piece clamping unit 14 is also extendable from, and retractable toward, connecting member 13 and/or mounting unit 12 as shown by arrow Y in FIG. 2.

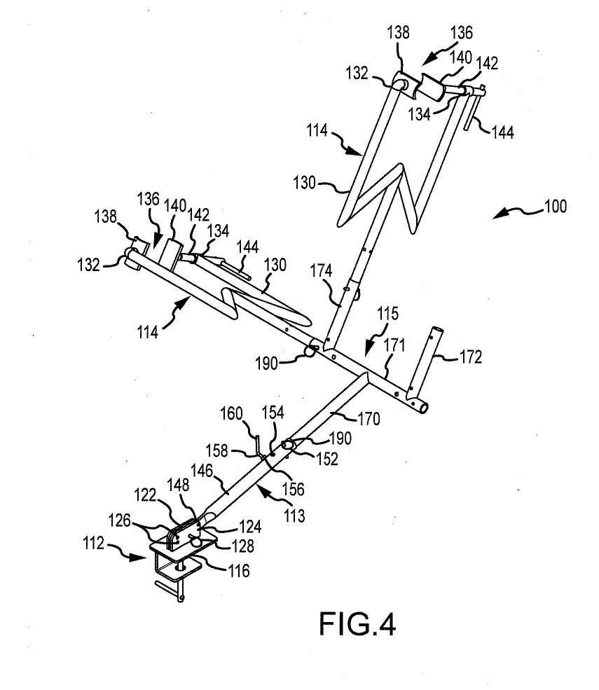

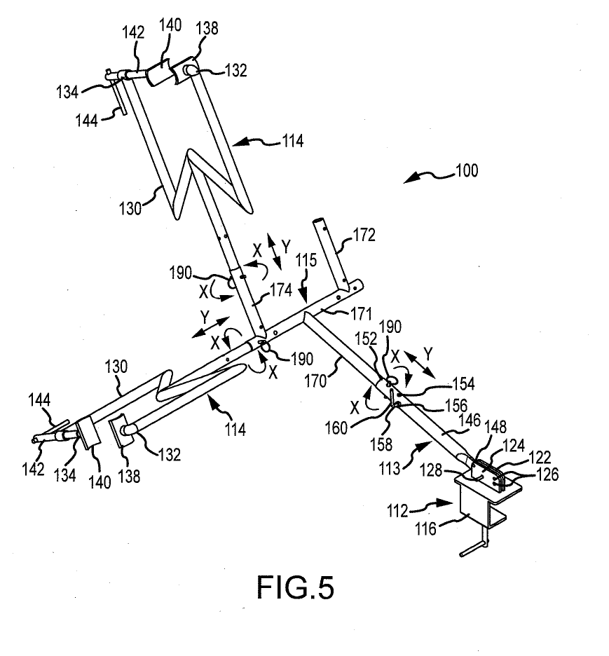

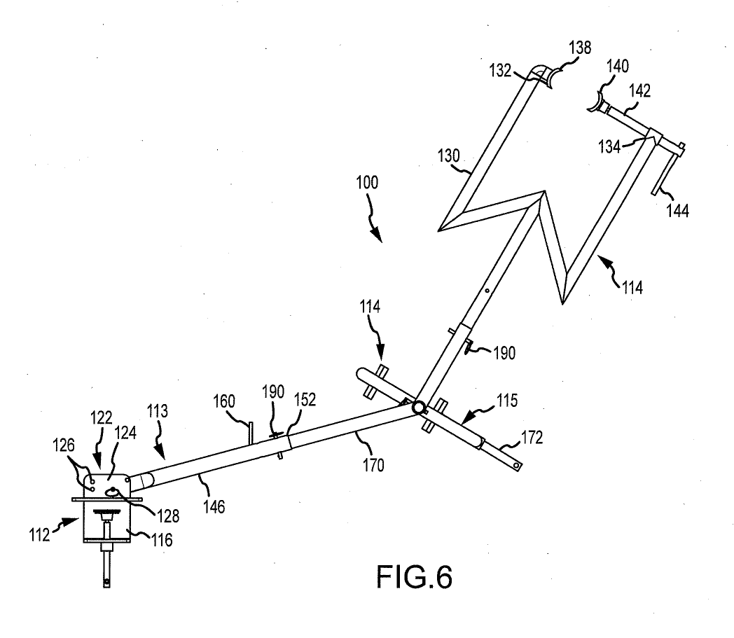

FIGS. 4-6 show another exemplary embodiment of the multi-functional vise 100 of the present invention with FIG. 4 showing a perspective view. FIG. 5 is an opposite perspective view of the exemplary embodiment of the vise 100 shown in FIG. 4 and FIG. 6 is a side elevational view of the exemplary embodiment of the vise 100 shown in FIGS. 4 and 5. As can be seen in FIGS. 4-6, the multi-functional vise 100 includes a mounting unit 112, a plurality of work piece clamping units 114 having a generally “M” shape, and connecting members 113, 115 which function to connect the work piece clamping units 114 to the mounting unit 112.

Mounting member 112 differs from mounting unit 12 in FIGS. 1-3 in that the slot 122 with outer walls 124 that contain openings 126 for receiving pin members 128 is positioned on a top of the clamp member 116. Connecting member 113 is the same as connecting member 13 in FIGS. 1-3 and includes a main member 146 having a first end 148 with openings (not shown) contained therein and a second end 152 with openings 154 contained therein. Connecting member 113 also includes a screw member 158 capable of fitting within openings 154, a lever 160 as part of, or connected to, screw member 158 for turning screw member 158, and a nut 156 for tightening and securing screw member 158 within openings 154.

Connecting member 115 includes a first member 170 that is connected perpendicularly to a midpoint of a second member 171 and third and fourth members 172, 174 that are each connected perpendicularly to second member 171 near opposite ends of second member 171 so that third and fourth members 172,174 are positioned parallel to one another. Open ends of connecting members 113, 115 can be connected to one another and any remaining open ends of connecting members 113, 115 that are not connected to one another may be connected to work piece clamping units 114. Openings are contained within both connecting members 113, 115 and work piece clamping members 114 so that the connecting members 113, 115 and/or work piece clamping members 114 can be extended or retracted from one another as shown by arrows Y in FIG. 5. In addition, connecting member 115 can be rotated 360 degrees relative to connecting member 113 and work piece clamping members 114 can be rotated 360 degrees relative to connecting member 115 as shown by arrows X in FIG. 5.

Each work piece clamping unit 114 is like work piece clamping unit 14 shown in FIGS. 1-3 and includes a generally “M” or “W” shaped member 130 (hereinafter referred to as “M” shaped member 130) which has a first end 132 and a second end 134 and a clamp 136 attached to the first and second ends 132, 134. Clamp 136 includes a fixed jaw member 138 attached to the first end 132 of “M” shaped member 130 and a moveable jaw member 140 attached to the second end 134 of the “M” shaped member 130. Clamp 136 further includes a screw member 142 connected to the moveable jaw member 140 and a lever 144 connected to the screw member 142 so that the lever 144 can turn the screw member 142 thereby moving the moveable jaw member 140 toward the fixed jaw member 138 so that a work piece can be retained within clamp 136.

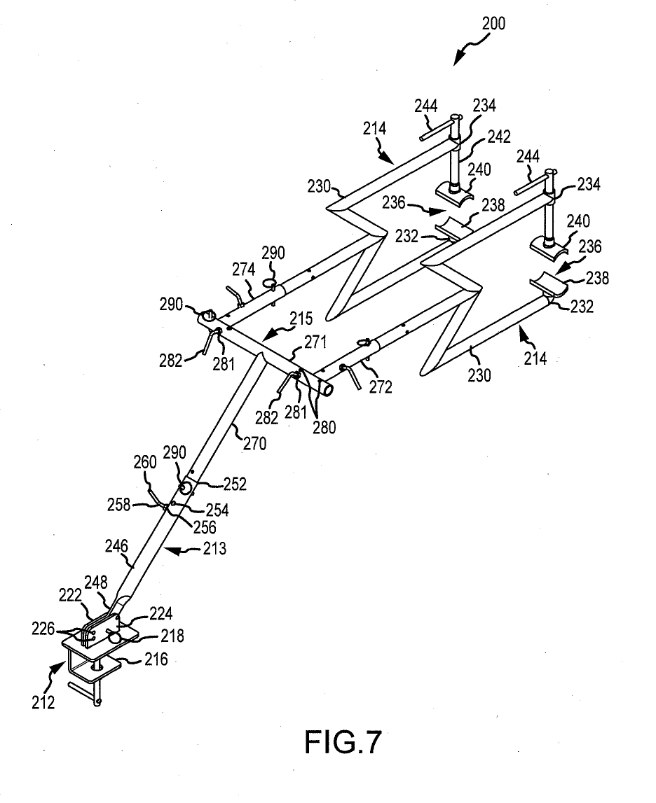

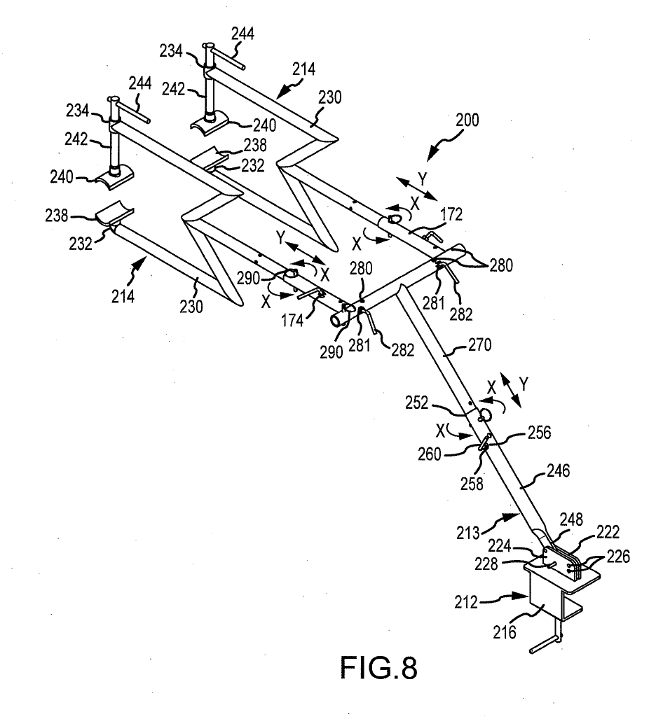

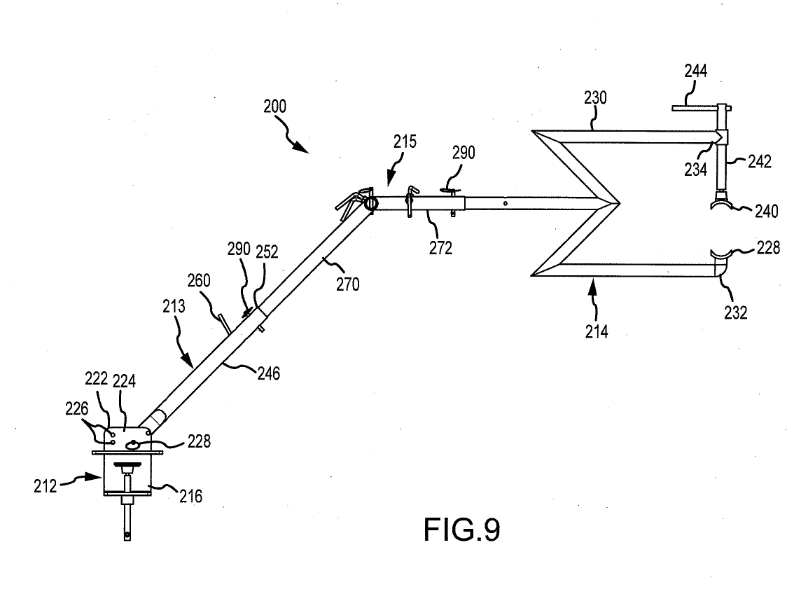

FIGS. 7-9 show another exemplary embodiment of the multi-functional vise 200 of the present invention with FIG. 7 showing a perspective view. FIG. 8 is an opposite perspective view of the exemplary embodiment of the vise 200 shown in FIG. 7 and FIG. 9 is a side elevational view of the exemplary embodiment of the vise 200 shown in FIGS. 7 and 8. As can be seen in FIGS. 7-9, the multi-functional vise 200 includes a mounting unit 212, a plurality of work piece clamping, units 214 having a generally “M” shape, and connecting members 213, 215 which function to connect the work piece clamping units 214 to the mounting unit 212.

Mounting member 212 is like mounting unit 112 in FIGS. 4-6 in that the slot 222 with outer walls 224 that contain openings 226 for receiving pin members 228 is positioned on a top of the clamp member 216. Connecting member 213 is the same as connecting member 13 in FIGS. 1-3 and connecting member 113 in FIGS. 4-6 and includes a main member 246 having a first end 248 with openings (not shown) contained therein and a second end 252 with openings 254 contained therein. Connecting member 213 also includes a screw member 258 capable of fitting within openings 254, a lever 260 as part of, or connected to, screw member 258 for turning screw member 258, and a nut 256 for tightening and securing screw member 258 within openings 254.

Like connecting member 115 in FIGS. 4-6, connecting member 215 includes a first member 270 that is connected perpendicularly to a midpoint of a second member 271 and third and fourth members 272, 274 that are each connected perpendicularly to second member 271 near opposite ends of second member 271 so that third and fourth members 272, 274 are positioned parallel to one another. Open ends of connecting members 213, 215 can be connected to one another and the remaining, open ends of connecting member 215 that are not connected to connecting member 214 may be connected to work piece clamping units 214 and for additional connecting members 215 (not shown). FIGS. 7-9 show two work piece clamping units 114 connected to open ends of connecting member 215 and two open ends of connecting member 215 without any work piece clamping units or other connecting members connected to them. However, openings 280 and screw members 281 and levers 282 enable additional work piece clamping members and/or connecting members to be connected to these open ends. The openings are contained within both connecting members 213, 215 and work piece clamping members 214 so that the connecting members 213, 215 and/or work piece clamping members 214 can be extended or retracted from one another as shown by arrows Y in FIG. 8. In addition, connecting member 215 can be rotated 360 degrees relative to connecting member 213 and work piece clamping members 214 can be rotated 360 degrees relative to connecting member 215 as shown by arrows X in FIG. 8.

Each work piece clamping unit 214 is like work piece clamping unit 14 shown in FIGS.

1-3 and work piece clamping unit 114 shown in FIGS. 4-6 and includes a generally “M” or “W” shaped member 230 (hereinafter referred to as “M” shaped member 230) which has a first end 232 and a second end 234 and a clamp 236 attached to the first and second ends 232, 234. Clamp 236 includes a fixed jaw member 238 attached to the first end 232 of “M” shaped member 230 and a moveable jaw member 240 attached to the second end 234 of the “M” shaped member 230. Clamp 236 further includes a screw member 242 connected to the moveable jaw member 240 and a lever 244 connected to the screw member 242 so that the lever 244 can turn the screw member 242 thereby moving the moveable jaw member 240 toward the fixed jaw member 138 so that a work piece can be retained within clamp 236.

As can be seen by the exemplary embodiments shown in FIGS. 1-9, the multi-functional vise of the present invention is capable of many varying configurations using the work piece clamping units 14, 114, 214 and the connecting members 13, 113, 115, 213, 215 to in turn connect to the mounting unit 12, 112, 212. A number screw members and levers for securing the work piece clamping units and connecting members to one another may be positioned at various lengths along the units and members through openings contained in the units and members and additional security pins 190, 290 (see FIGS. 4-9) may also be placed through the openings contained in the units and members to ensure that the connection remains secure in the event that screw members connecting the units and members fail.

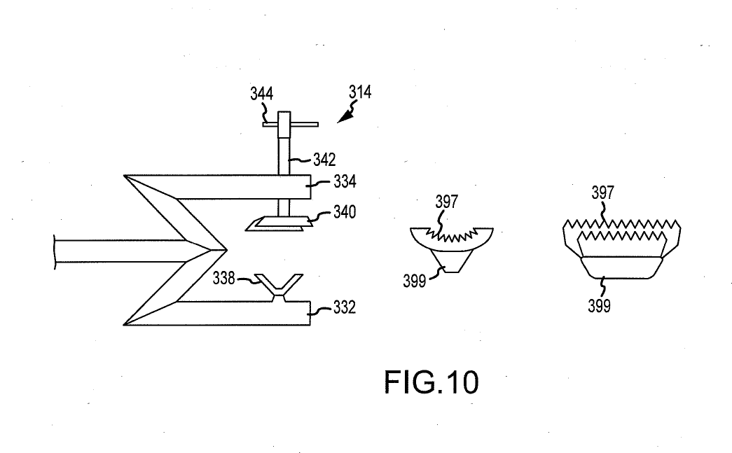

FIG. 10 is partial perspective view of an exemplary embodiment of an “M” shaped work piece clamping unit 314 of the multi-functional vise of the present invention. In this exemplary embodiment, “M” shaped work piece clamping unit 314 includes a first end 332, a second end 334, a fixed jaw member 338 connected to the first end 332, and a movable jaw member 340 connected to the second end 334. The moveable jaw member 340 is moved toward or away from the fixed jaw member by screw member 342 and lever 344 which functions to turn screw member 342. Both fixed jaw member 338 and moveable jaw member 340 include teeth members 397 for grabbing and holding a work piece within work piece clamping unit 314. In addition, the base 398 of both the fixed jaw member 338 and the moveable jaw member 340 may comprise magnetic bases.

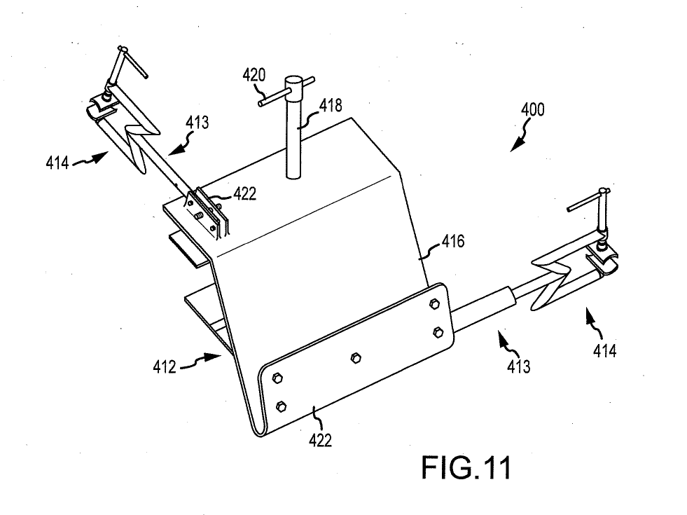

FIG. 11 is a perspective view of still another exemplary embodiment of the multi-functional vise 400 of the present invention. Multi-functional vise 400 includes a mounting unit 412, two connecting members 413 attached to the mounting unit 412, and an “M” shaped work piece clamping unit 414 attached to each of the connecting members 413. Mounting unit 412 includes two slot members 422 for receiving the connecting members 413. The slot members 422 may take the form of any of the previous slot members described above with reference to FIGS. 1-9. Mounting unit 412 includes a clamp member 416, a screw member 418 connected to the clamp member 416, and a lever 420 connected to the screw member 418 so that it can turn screw member 416 in clockwise and counterclockwise directions thereby closing and opening the jaws of clamp member 416. In this exemplary embodiment of multi-functional vise 400, a regular or standard sized “M” shaped work piece clamping member (as shown In FIGS. 1-9) is attached to the mounting unit via a regular sized connecting member (as shown in FIGS. 1-9) and a smaller sized “M” shaped work piece clamping member is attached to the mounting member via a smaller sized connecting member to enable smaller jobs with smaller work pieces to be performed.

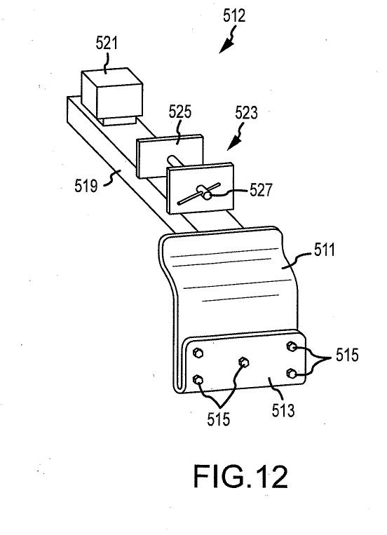

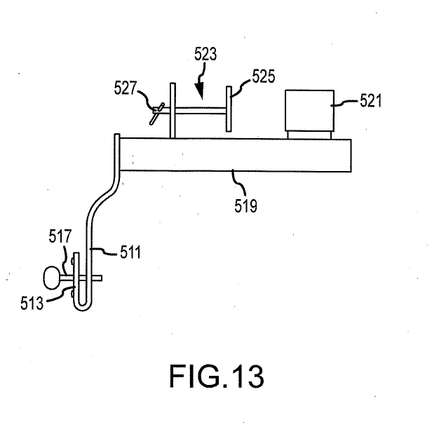

FIG. 12 is a perspective view of an exemplary embodiment of a mounting unit 512 of the multi-functional vise of the present invention and FIG. 13 is a side elevational view of the exemplary embodiment of the mounting unit 512 of the multi-functional vise shown in FIG. 12. Mounting unit 512 is particularly designed for an under rail mount on a truck and includes a clamp arm 511 having a lip member 513 (or slot such as those previously described above) for receiving a connecting member or work piece clamping unit such as those previously described above with reference to FIGS. 1-9 and openings 515 within lip member 513 and screw member 517 (see FIG. 13) for securing the connecting member or work piece clamping unit within the clamp arm 511. The mounting unit 512 also includes a mounting member 519 solidly and securely connected to an upper portion of the clamp arm 511 (in addition the clamp arm 511 and the mounting member 519 may be comprised of one continuous piece), a heavy duty magnetic piece 521, an adjustable tightening unit 523 with a movable platform 525, and a tightening member or screw member 527 for moving the movable platform 525 toward and away from the magnetic piece 512 so that an under rail of a truck can be securely fixed between the magnetic piece 521 and the moveable platform 525.

FIG. 14 is a perspective view of yet another exemplary embodiment of the multi-functional vise 600 of the present invention. As shown in FIG. 14, the multi-functional vise 600 is the same as the multi-functional vise 10 shown in FIGS. 1-3 with the exception of the mounting unit and the deletion of the connecting member. Mounting unit 612 in multi-functional vise 600 includes a sleeve member 623 in place of the slot 22 of the mounting unit 12 shown in FIGS. 1-3 so that work piece clamping unit 614 can be inserted directly into the sleeve member 623 such that it can be extended from and retracted toward the mounting unit 612. However, it should be understood that this exemplary embodiment could also include a connecting member, if desired, that has a rounded or circular end capable of being received into the sleeve member 623 of the mounting unit 612 and the work piece clamping unit 614 would then in turn be connected to the connecting member.

The detailed description of exemplary embodiments of the invention herein shows various exemplary embodiments and the best modes, known to the inventor at this time, of the invention. These exemplary embodiments and modes are described in sufficient detail to enable those skilled in the art to practice the invention and are not intended to limit the scope, applicability, or configuration of the invention in any way. Rather, the following disclosure is intended to teach both the implementation of the exemplary embodiments and modes and any equivalent modes or embodiments that are known or obvious to those reasonably skilled in the art. Additionally, all included figures are non-limiting illustrations of the exemplary embodiments and modes, which similarly avail themselves to any equivalent modes or embodiments that are known or obvious to those reasonably skilled in the art.

Other combinations and/or modifications of structures, arrangements, applications, proportions, elements, materials, or components used in the practice of the instant invention, in addition to those not specifically recited, can be varied or otherwise particularly adapted to specific environments, manufacturing specifications, design parameters, or other operating requirements without departing from the scope of the instant invention and are intended to be included in this disclosure.

Unless specifically noted, it is the Applicant's intent that the words and phrases in the specification and the claims be given the commonly accepted generic meaning or an ordinary and accustomed meaning used by those of ordinary skill in the applicable arts. In the instance where these meanings differ, the words and phrases in the specification and the claims should be given the broadest possible, generic meaning. If any other special meaning is intended for any word or phrase, the specification will clearly state and define the special meaning.

1. A multi-functional vise comprising:
a mounting unit; and
a work piece clamping unit connected to the mounting unit wherein the work piece clamping unit is capable of being rotated 360 degrees and is extendable from and retractable toward the mounting unit.

2. The multi-functional vise of claim 1 wherein the work piece clamping unit comprises an “M” shape.

3. The multi-functional vise of claim 1 further comprising a connecting member positioned between the work piece mounting unit and the clamping unit such that opposite ends of the connecting member are connected to the mounting unit and the work piece clamping unit, respectively.

4. The multi-functional vise of claim 3 wherein the work piece clamping unit is capable of being rotated 360 degrees in relation to the connecting member.

5. The multi-functional vise of claim 4 wherein the work piece clamping unit is capable of being extended from and retracted toward the connecting member.

6. The multi-functional vise of claim 5 wherein the mounting unit comprises a slot and the end of the connecting member connected to the mounting unit fits within the slot.

7. The multi-functional vise of claim 6 wherein the work piece clamping unit comprises an “M” shape.

8. The multi-functional vise of claim 7 wherein the “M” shaped work piece clamping unit has first and second ends and a clamp connected to the first and second ends.

9. The multi-functional vise of claim 8 wherein the clamp comprises a fixed jaw member attached to the first end of the “M” shaped work piece clamping unit and a moveable jaw member attached to the second end of the “M” shaped work piece clamping unit.

10. The multi-functional vise of claim 9 wherein the clamp further comprises a screw member connected to the moveable jaw member and a lever connected to the screw member so that the lever can turn the screw member and thereby move the moveable jaw member toward the fixed jaw member.

11. The multi-functional vise of claim 10 wherein the moveable jaw member and the fixed jaw member each have a plurality of teeth members for grasping a work piece.

12. A multi-functional vise comprising:
a mounting unit having a slot member;
at least one work piece clamping unit; and
a connecting member connecting the mounting unit to the at least one work piece clamping unit wherein the connecting member comprises a first end which fits within the slot of the mounting unit and a second end which is connectable to the at least one work piece mounting unit.

13. The multi-functional vise of claim 12 wherein the mounting unit comprises a clamp member and a screw member for mounting the mounting unit to a structure.

14. The multi-functional vise of claim 13 wherein a portion of the clamp member comprises a magnet.

15. The multi-functional vise of claim 12 wherein the at least one work piece clamping unit is capable of being rotated 360 degrees in relation to the connecting member.

16. The multi-functional vise of claim 12 wherein the at least one work piece clamping unit is capable of being extended from and retracted toward the connecting member.

17. The multi-functional vise of claim 12 wherein the at least one work piece clamping unit comprises at least one “M” shaped member.

18. The multi-functional vise of claim 17 wherein the at least one “M” shaped member has first and second ends and a clamp connected to the first and second ends.

19. The multi-functional vise of claim 18 wherein the clamp comprises a fixed jaw member attached to the first end of the “M” shaped member and a moveable jaw member attached to the second end of the “M” shaped member.

20. The multi-functional vise of claim 19 wherein the clamp further comprises a screw member connected to the moveable jaw member and a lever connected to the screw member so that the lever can turn the screw member and thereby move the moveable jaw member toward the fixed jaw member.

21. The multi-functional vise of claim 20 wherein the moveable jaw member and the fixed jaw member each have a plurality of teeth members for grasping a work piece.
